(19) United States
(12) Patent Application Publication
(10) Pub. No.: US 2015/0128380 A1
(43) Pub. Date: May 14, 2015

(54) SPRING HINGE FOR SPECTACLES

(71) Applicant: Harald Buchegger, St. Konrad (AT)

(72) Inventor: Harald Buchegger, St. Konrad (AT)

(73) Assignee: REDTENBACHER Präzisionsteile Ges.m.b.H., Scharnstein (AT)

(21) Appl. No.: 14/397,649

(22) PCT Filed: Jun. 1, 2012
(86) PCT No.: PCT/AT2012/050078

§ 371 Date: Oct. 29, 2014

(51) Int. Cl. G02C 5/22

(52) U.S. Cl. CPC G02C 5/2245
USPC 16/228

(57) ABSTRACT

A spring hinge for spectacles is described having a hinge part (2) forming a bearing fork (1) for a hinge axis (3), having a guide head (6), which is provided between the two fork legs (8) of the bearing fork (1) and is fastenable on a spectacle part (7), for the hinge part (2), and having a coiled spring (13) between the guide head (6) and the hinge part (2), which is displaceable in relation to the guide head (6), on the side of the guide head (6) facing away from the hinge axis (3). To provide simple design conditions, it is proposed that the section of the hinge part (2) accommodating the coiled spring (13) be implemented as a hinge housing (11), and the guide head (6) comprise a middle part (9), which penetrates the bearing fork (1) of the hinge part (2) between the two fork legs (8) and forms a pivot axis for the hinge housing (11), having lateral guide flanges (10) which encompass the fork legs (8) on both sides.

### FIELD OF THE INVENTION

The invention relates to a spring hinge for spectacles having a hinge part forming a bearing fork for a hinge axis, having a guide head, which is provided between the two fork legs of the bearing fork and is fastenable on a spectacle part, for the hinge part, and having a coiled spring between the guide head and the hinge part, which is displaceable in relation to the guide head, on the side of the guide head facing away from the hinge axis.

### DESCRIPTION OF THE PRIOR ART

To be able to easily replace a housing of a spring hinge, which is otherwise fixedly connected to a spectacle part, typically to a spectacle earpiece, between earpiece and temple of spectacles, associating the displacement guide for the sliding part carrying the bearing fork not with the housing, but rather with a separate guide head, which is fastened on the relevant spectacle part, is known (DE 10 2009 012 836 A1), so that the housing, which is freed of the guide tasks for the hinge part having the bearing fork, can be detachably connected in a simple manner to the guide head. The guide head forms in this case a displacement guide provided between the two legs of the U-shaped sliding part, for example, between which and the web connecting the two legs of the sliding part, the coiled spring loading the spring hinge is supported. Although the hinge housing can be designed more simply due to the provision of a separate guide head, which is fixedly connected to a spectacle part, for the hinge part, a structural simplification hardly results.

In addition, arranging a guide rail on a spectacle part for the hinge housing which accommodates the coiled spring of a spring hinge is known (KR 20090028603 A), so that the hinge housing is displaceably mounted in the direction of the axis of the coiled spring. Since the hinge housing forms a bearing fork for accommodating a hinge lobe and the coiled spring is supported on one side on the guide rail and on the other side on the housing, the hinge lobe is drawn by the coiled spring via the housing to stop against the guide rail. A comparatively short construction can therefore be maintained, because the housing also carries out the movement of the spring hinge. However, it is disadvantageous that overstretching of the spring hinge can only occur in one direction.

### SUMMARY OF THE INVENTION

The invention is therefore based on the object of providing a spring hinge for spectacles, which not only has a simple construction, but rather also provides greater security in relation to overstretching.

Proceeding from a spring hinge of the type described at the outset, the invention achieves the stated object in that the section of the hinge part which accommodates the coiled spring is implemented as a spring housing, and the guide head comprises a middle part, which penetrates the bearing fork of the hinge part between the two fork legs and forms a pivot axis for the hinge housing, having lateral guide flanges which enclose the fork legs on both sides.

By way of these measures, not only is the hinge housing omitted, which otherwise determines the structural length of the spring hinge, but rather advantageous conditions are provided for a possible additional pivot of the hinge housing about an axis perpendicular to the hinge axis, because the guide head can comprise a middle part, which penetrates the bearing fork of the hinge part between the two fork legs and forms a pivot axis for the hinge housing, having lateral guide flanges which enclose the fork legs on both sides, so that the spring hinge enables overstretching in two axes perpendicular to one another. This additional pivot movement against spring force can be limited by pivot stops, which are formed by the guide head. In order that no additional measures are necessary in the region of the hinge housing in this context, the pivot stops of the guide head can cooperate with an attachment of a hinge lobe mounted in the bearing fork, since it can be presumed that this hinge lobe is guided without play between the bearing forks.

To simplify the installation conditions, the guide flanges of the guide head can have a length measured in the displacement direction of the hinge part which corresponds at most to the mutual spacing of the fork legs, wherein the end sections of the fork legs accommodating the hinge axis form a stop overlapping the guide flanges. Because of these measures, the bearing fork of the hinge part forming the hinge housing, after the insertion of the coiled spring, can be pushed transversely to the proper displacement direction onto the middle part of the guide head, with pre-tensioning of the coiled spring, until the stops of the preferably enlarged end sections of the fork legs protrude beyond the guide flanges. After a 90° pivot of the hinge part about the middle part of the guide head, the stops of the fork legs engage behind the guide flanges and are held in this stop position by the pre-tensioned coiled spring. Only the middle hinge lobe then still needs to be inserted between the fork legs and fixed with the aid of the hinge axis.

### BRIEF DESCRIPTION OF THE DRAWING

The subject matter of the invention is shown as an example in the drawing. In the figures:

FIG. 1 shows a spring hinge for spectacles according to the invention in a partially cutaway side view,

FIG. 2 shows this spring hinge in a top view,

FIG. 3 shows an illustration corresponding to FIG. 2 of the spring hinge in an overstretched location in relation to a transverse axis,

FIG. 4 shows the hinge part, in an installed position with the bearing fork pushed onto the guide head, in a partially cutaway top view, and

FIG. 5 shows the hinge part, which is pivoted out of the installation position according to FIG. 4 into the usage position, in a side view.

### DESCRIPTION OF THE PREFERRED EMBODIMENT

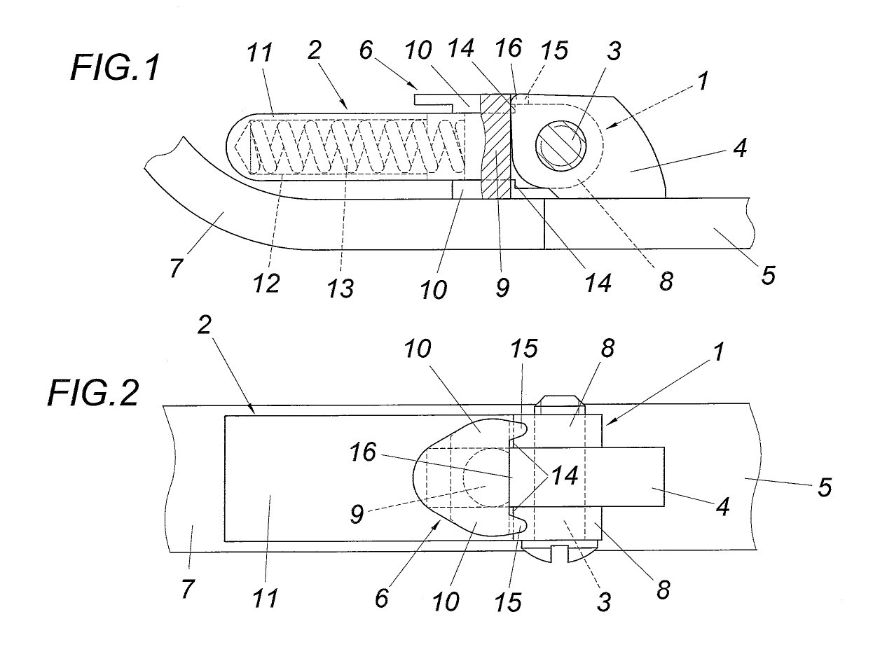

The spring hinge according to FIGS. 1 and 2 has a hinge part 2, which forms a bearing fork 1, and a hinge lobe 4, which engages in the bearing fork 1 and is connected thereto via a hinge axis 3. While the middle hinge lobe 4 is fastened directly to a spectacle part, in the exemplary embodiment to the spectacle earpiece 5, the hinge part 2 is displaceably mounted via a guide head 6 on the other spectacle part, in the exemplary embodiment the earpiece temple 7. For this purpose, the guide body 6 forms a middle part 9, which is enclosed by the two fork legs 8 of the bearing fork 1, and which forms laterally protruding guide flanges 10 overlapping the fork legs 8, so that the hinge part 2 can be displaced between the guide flanges 10 radially in relation to the middle part 9.

The hinge part 2 is embodied in the form of a hinge housing 11, which has a receptacle opening 12 for a coiled spring 13 and which carries the two fork legs 8 to implement the bearing fork 1. The arrangement is made in this case so that the coiled springs 13 are supported, on the side of the guide head 6 facing away from the spring axis 3, on the middle part 9 and on the base of the receptacle opening 12, with the effect that the coiled spring 13 attempts to press the guide head 6 out of the bearing fork 1. The displacement path of the hinge part 2, which is caused by the spring application, in relation to the guide head 6 is delimited at the stops 14, which are implemented on the preferably enlarged end sections of the fork legs 8, and which engage at the end side behind the guide flanges 10. However, since the middle hinge lobe 4 is to press against the guide head 6 under the influence of the coiled spring 13 in the stretched position of the spectacle earpiece 5, at least in the earpiece stretched location, the hinge lobe 4, when the stops 14 are lifted, determines the displacement location of the hinge part 2 in relation to the guide head 6, as is apparent from FIGS. 1 and 2.

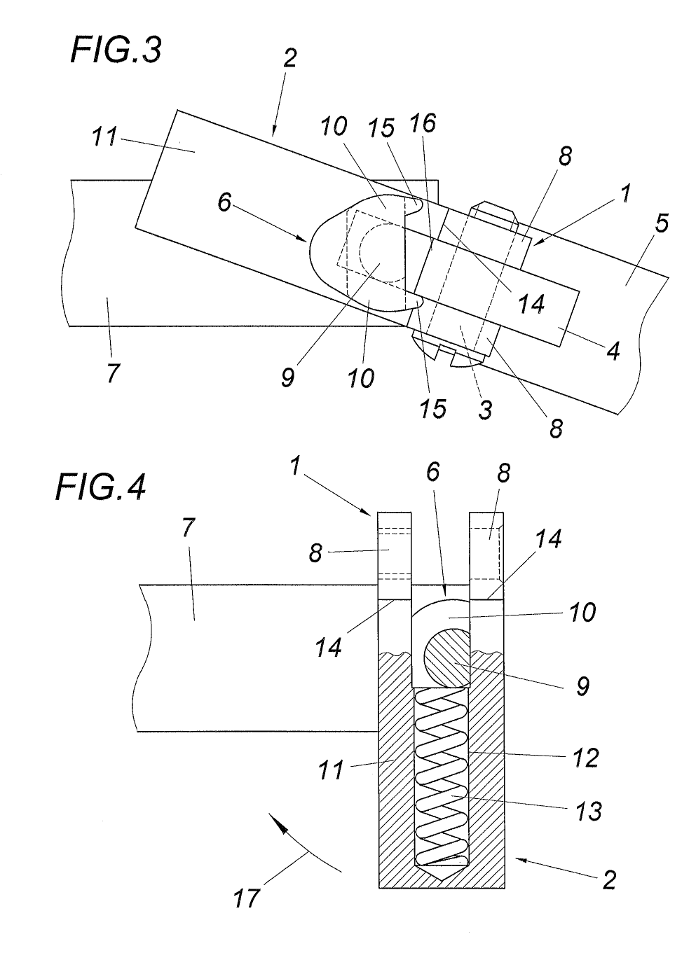

If the middle part 9 of the guide head 6 is implemented as a pivot axis for the hinge part 2, overstretching of the spring hinge is also possible in relation to this pivot axis, which is illustrated in FIG. 3. To limit the pivot movement of the hinge part 2 about the middle part 9 of the guide head 6, the guide head 6 can be provided with pivot stops 15, which interact in the illustrated exemplary embodiment with a protruding attachment 16 of the hinge lobe 4, but this is not required.

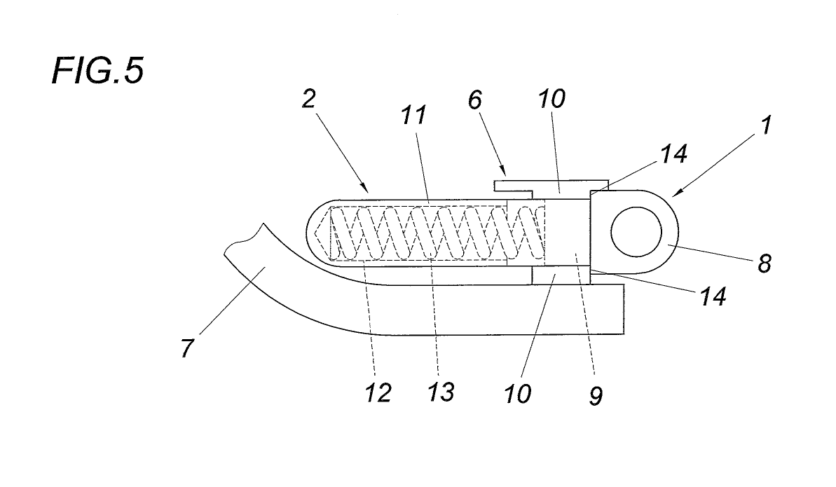

The simple installation capability for a spring hinge according to the invention is clear from FIGS. 4 and 5. After the insertion of the coiled spring 13 into the receptacle opening 12 of the hinge housing 11, the hinge part 2 with its bearing fork 1 is pushed onto the guide head 6 transversely to the correct displacement direction. As may be seen from FIG. 4, the guide flanges 10 cannot have a length measured in the displacement direction which exceeds the mutual spacing between the fork legs 8 for this purpose. If the stops 14 protrude beyond the enlarged end sections of the fork legs 8 in this installation position of the guide flanges 10, the hinge part can thus be pivoted according to the arrow 17 into the usage position according to FIG. 5, wherein the stops 14 of the enlarged end sections of the fork legs 8 overlap the end sides of the guide flanges, so that the pre-tension of the coiled spring 13 which accompanies the pushing of the bearing fork 1 onto the guide head 6 is maintained. The middle hinge lobe 4 can then be mounted with the aid of the hinge axis 3 in the bearing fork 1 of the hinge part 2.

1. A spring hinge for spectacles having a hinge part (2) forming a bearing fork (1) for a hinge axis (3), having a guide head (6), which is provided between the two fork legs (8) of the bearing fork (1) and is fastenable on a spectacle part (7), for the hinge part (2), and having a coiled spring (13) between the guide head (6) and the hinge part (2), which is displaceable in relation to the guide head (6), on the side of the guide head (6) facing away from the hinge axis (3), wherein the section of the hinge part (2) accommodating the coiled spring (13) is implemented as a hinge housing (11), and the guide head (6) comprises a middle part (9), which penetrates the bearing fork (1) of the hinge part (2) between the two fork legs (8) and forms a pivot axis for the hinge housing (11), having lateral guide flanges (10) which encompass the fork legs (8) on both sides.

2. The spring hinge according to claim 1, wherein the guide head (6) has pivot stops (15) for limiting the pivot angle of the hinge housing (11).

3. The spring hinge according to claim 2, wherein the pivot stops (15) of the guide head (6) interact with an attachment (16) of a hinge lobe (4) mounted in the bearing fork (1).

4. The spring hinge according to claim 1, wherein the guide flanges (10) of the guide head (6) have a length measured in the displacement direction of the hinge part (2), which corresponds at most to the mutual spacing of the fork legs (8), and the end sections of the fork legs (8) accommodating the hinge axis (3) form a stop (14) overlapping the guide flanges (10).
